(19) United States
(12) Patent Application Publication
(10) Pub. No.: US 2026/0076781 A1
(43) Pub. Date: Mar. 19, 2026

(54) ZYGOMATIC DENTAL IMPLANT

(71) Applicant: Alex FIBISHENKO, Burwood East (AU)

(72) Inventor: Alex FIBISHENKO, Burwood East (AU)

(21) Appl. No.: 19/109,892

(22) PCT Filed: Oct. 3, 2023
(86) PCT No.: PCT/AU2023/050950

§ 371 Date: Mar. 7, 2025

(30) Foreign Application Priority Data
Oct. 5, 2022 (AU) 2022902890

(51) Int. Cl. A61C 8/00

(52) U.S. Cl. CPC A61C 8/0034; A61C 8/0022; A61C 8/0037; A61C 8/0056

(57) ABSTRACT

A zygomatic dental implant having an elongate body comprising: an elongate apical portion for anchoring the implant in zygoma bone of a patient, the apical portion having a central longitudinal axis; a coronal portion having an internally threaded bore via which an abutment can be engaged with the implant; and an intermediate portion extending between the apical portion and the coronal portion, wherein a cross-sectional shape of the intermediate portion and/or the coronal portion, taken along a plane perpendicular to the central longitudinal axis, is ovoid.

### FIELD OF THE INVENTION

The present disclosure relates to restorative dental implants, and in particular, zygomatic dental implants.

### BACKGROUND

Zygomatic dental implants are longer than more traditional dental implants and are commonly required for patients with resorbed and/or deteriorated jaw bones.

Prior art zygomatic implants have a generally cylindrical body having: a distal or apical portion for anchoring the implant in zygoma bone of the patient; a proximal or coronal portion having an angled platform via which a structure, such as an angulated abutment, can be secured; and an intermediate portion extending between the apical and coronal portions.

The bodies of certain prior art zygomatic implants have a generally flat surface or side configured to engage soft tissue of the patient, with the aim of reducing bulging which can in in resulting thinning of the soft tissue (which can be more aesthetically pleasing). However, the incorporation of the flat surface results in an implant with sharper edges, particularly where the flat surface meets the angled platform. Such sharp surfaces are known to infringe and irritate the soft tissue of the patient and can cause irritation of the gums and lead to recession and/or infection around the implant which can be difficult to treat. External threading on the apical portion can also end up in the patient's soft tissue.

To reduce the risk of recession and/or infection, a surgeon may alter the position and/or angle of the zygomatic implant to avoid biologic infringement on the buccal aspect, however this can result in infringement into spaces on the medial aspect (like the maxillary sinus or sublingual space), or positioning the implants palatal to (and outside of) the teeth-arch form which can cause (i) difficulty cleaning and subsequent risk of infection, (ii) reduced restorative space, risk of breakages and reduced durability, and (iii) bulky restoration causing issues with comfort and speech.

While angulated abutments can help correct the angulation of the zygomatic implant, they are often bulkier and there may be increased patient discomfort and infringement on soft tissue. Additionally, when angulated abutments are combined with angled platforms, an angle between the abutment and the implant can become acute on one side and can infringe on the biologic width and increase risk for recession and/or infection.

There is a need to address the above, and/or at least provide a useful alternative. One or more embodiments of the present zygomatic dental implant seek to improve aesthetics, biostability, cleanability, durability and/or patient comfort.

### SUMMARY

According to a first aspect of the present invention, there is provided a zygomatic dental implant having an elongate body comprising:
an elongate apical portion for anchoring the implant in zygoma bone of a patient, the apical portion having a central longitudinal axis;
a coronal portion having an internally threaded bore via which an abutment can be engaged with the implant; and
an intermediate portion extending between the apical portion and the coronal portion,
wherein a cross-sectional shape of the intermediate portion and/or the coronal portion, taken along a plane perpendicular to the central longitudinal axis, is ovoid.

The ovoid cross-sectional shape may be formed by a meeting of first and second curves having different lengths.

The first curve may comprise a first arc having a first diameter and the second curve may comprise a second arc having a second diameter that is different from the first diameter. In certain embodiments, a majority of a perimeter of the ovoid cross-sectional shape is defined by the first arc.

Moving in a coronal direction, the perimeter of the ovoid cross-sectional shape may be increasingly defined by the second arc.

It is envisaged that the ovoid cross-sectional shape comprises an axis of symmetry passing through respective centres of the first and second arcs.

In at least one embodiment, the central longitudinal axis lies on a plane that bisects the apical portion, and it is envisaged that the axis of symmetry at a lower end of the intermediate portion is generally perpendicular to the plane.

Moving in the coronal direction, the axis of symmetry may grow increasingly acute relative to the plane that bisects the apical portion. Moreover, the centre of the second arc may rotate up to 90 degrees about the central longitudinal axis.

The coronal portion may comprise a generally planar platform facing a direction that is aligned with the centre of the second arc at an upper end of the coronal portion. In at least one example, the platform is angled from the plane that is perpendicular to the central longitudinal axis. For example, the implant may be angled by approximately 35 degrees to 45 degrees from the plane that is perpendicular to the central longitudinal axis.

It is envisaged that the internally threaded bore has a central bore axis that is generally perpendicular to the planar platform.

In certain embodiments:
the first arc forms part of a first circle having the first diameter; and
the second arc forms part of a second circle having the second diameter, the second diameter being greater than the first diameter by a predetermined numerical factor.

In at least one example, the first and second arcs meet at an intersection where a pair of third identical circles, each spaced from one another and contained within the first circle and having a third diameter that is the square root of the predetermined numerical factor, tangentially intersect both the first circle and the second circle.

It is envisaged that the predetermined numerical factor may be between approximately 1 and 2. For example, the predetermined numerical factor may be between approximately 1.5 and 1.7.

In certain embodiments, the apical portion comprises external threading and a smooth unthreaded tip portion. In at least one example, an upper end of the smooth tip portion slopes upwardly from a first side of the apical portion about the circumference thereof to an opposite second side of the apical portion so as to define an apex of the smooth tip portion.

It is envisaged that the slope of the upper end of the smooth tip portion is angled between approximately 10 to 60 degrees relative to the central longitudinal axis. In certain embodiments, it may be angled at approximately 35 degrees. In it envisaged that the apex of the smooth tip portion is aligned with the centre of the second arc at an upper end of the coronal portion.

### BRIEF DESCRIPTION OF THE DRAWINGS

An embodiment of the invention will now be described, by way of example only, with reference to the accompanying drawings in which:

FIG. 1 is a perspective view of a zygomatic dental implant according to embodiments of the present invention;

FIG. 2A is a right side view of the implant of FIG. 1;

FIG. 2B is a front view of the implant of FIG. 1;

FIG. 3A is a left side view of the implant of FIG. 1;

FIG. 3B is a rear view of the implant of FIG. 1;

FIG. 4A is a top cross-sectional view of the implant of FIG. 1 taken along A-A;

FIG. 4B is a schematic view of FIG. 4A showing a geometry thereof;

FIG. 5A is a top cross-sectional view of the implant of FIG. 1 taken along B-B;

FIG. 5B is a top cross-sectional view of the implant of FIG. 1 taken along C-C;

FIG. 6 is a view of the implant of FIG. 1 from a direction aligned with an interior bore thereof;

FIG. 7 is a top view of the implant of FIG. 1;

FIG. 8 is a close-up of an angled platform of the implant of FIG. 1; and

FIG. 9 is the same view as FIG. 6 showing an apex of the smooth tip portion aligned with a buccal surface of the implant at an upper end thereof.

### DETAILED DESCRIPTION

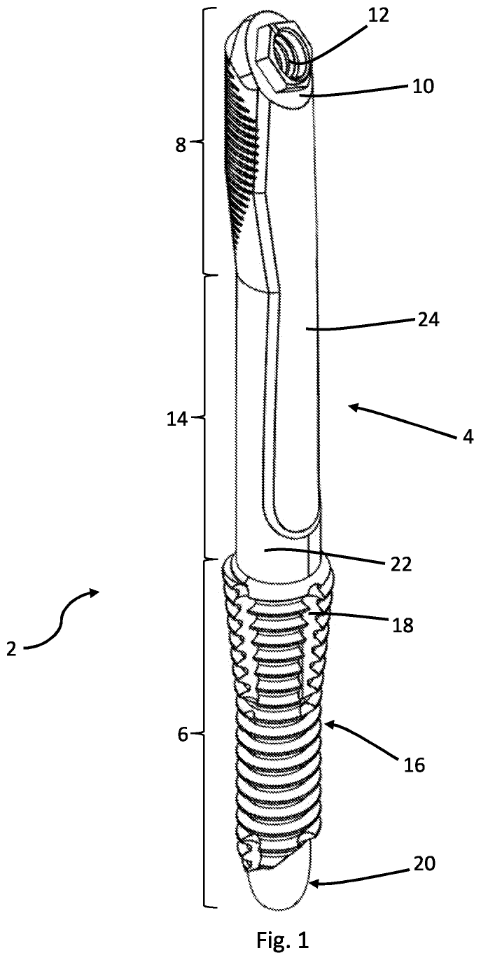

FIGS. 1 to 3A show various views of a zygomatic dental implant 2 according to embodiments of the present invention. The implant 2 has a generally elongate and integrally formed body 4, comprising a distal or apical portion 6 for anchoring the implant in zygoma bone of the patient. The elongate body 4 also comprises a proximal or coronal portion 8 having an angled planar platform 10 via which a structure, such as an abutment, can be secured to the implant 2 via an interior threaded bore 12 formed in an upper end of the coronal portion 8. The elongate body 4 also comprises a middle or an intermediate portion 14 extending between the apical and coronal portions 6, 8.

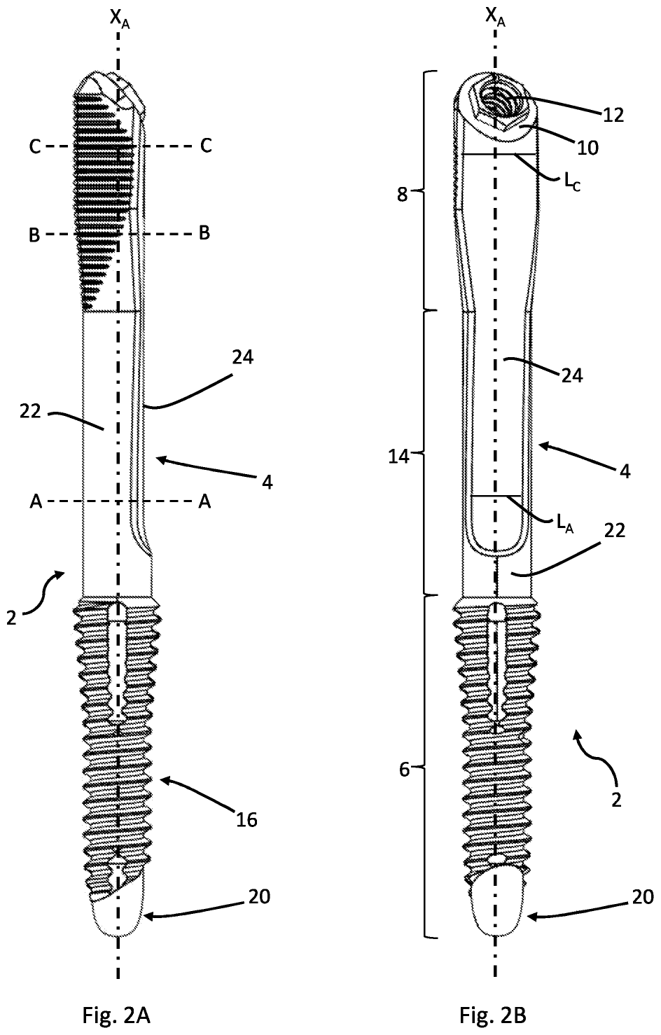

The apical portion 6 may carry an external thread 16 and/or flutes 18 via which the apical portion 6 can be anchored in the zygoma bone of the patient. The apical portion 6 may also have a polished and unthreaded smooth tip portion 20, and may taper slightly outwardly (e.g., grows in diameter) when moving in the direction of the coronal portion 8. In the depicted embodiment, the apical portion 6 is generally symmetrical about two planes and defines a central longitudinal axis extending through a length thereof. This central longitudinal axis is denoted as XA in FIGS. 2A to 3B and FIG. 8. While the apical portion 6 has two planes of symmetry, in the depicted embodiment, these planes do not bisect the intermediate portion 14 and/or the coronal portion 8 symmetrically. As will be discussed, in certain embodiments of the present implant 2, the intermediate and/or coronal portions 14, 8 are not symmetrically disposed about the central longitudinal axis X_{A} of the apical portion 6.

The intermediate portion 14 blends smoothly into and with the coronal portion 8 of the implant 2, and the two portions 8, 14 together define a first and second curved external surfaces 22, 24 of the elongate implant 2. When implanted, the second curved surface 24 is configured to engage soft tissue of the patient and hence the second curved surface 24 will also be referred to as a buccal surface 24 herein.

In contrast to prior art implants which comprise a generally flat or planar surface for engaging the patient's soft tissue, the present implant 2 comprises a curved buccal surface 24. Compared with a generally flat surface, the presently disclosed curved buccal surface 24 is able to blend or contour more smoothly and gradually with the angled platform 10 of the coronal portion 8 of the implant 2, thereby reducing the sharpness of any edges at the interface of the buccal surface 24 and the planar platform 10. By eliminating or at least reducing the roughness and sharpness of such edges, the presently disclosed implant 2 can deliver greater patient comfort while reducing the likelihood of irritation, infection etc.

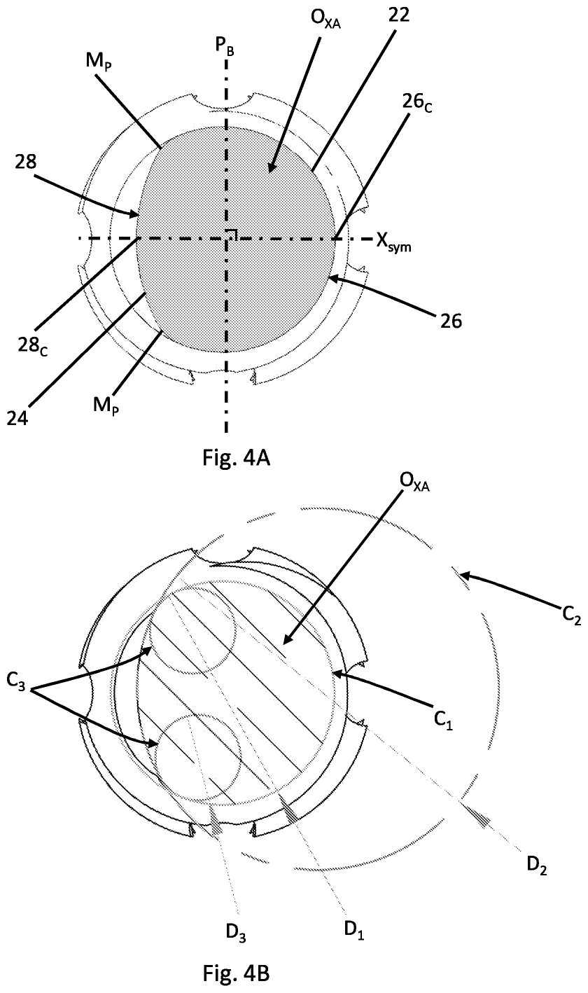

Referring also to FIG. 4A, the curvature of the buccal surface 24 is not the same as that of the first curved surface 22 of the implant 2. Instead, the curvature of the buccal surface 24 is comparably smaller (i.e., less curved) that than of the first curved surface 22. FIG. 4A shows a cross-sectional shape O_{XA} of a lower end of the intermediate portion 14 taken along the plane A-A (see FIG. 2A) which is perpendicular to the central longitudinal axis X_{A} of the apical portion 6. As can be seen, the cross-sectional shape O_{XA} of the intermediate portion 14 is generally ovoid and defined by the meeting of a first curve 26 and a second curve 28 having different lengths to one another. Unless specified otherwise, the term ‘ovoid’ is used herein to refer to an oval-like shape.

Still referring to FIG. 4A, the first curve 26 defines the curvature of the first curved surface 22 of the implant 2, while the second curve 28 defines the curvature of the buccal surface 24 of the implant 2. In the depicted embodiment, the first curve comprises a first arc 26 having a first diameter D₁, and the second curve comprises a second arc 28 having a second diameter D₂ that is greater than the first diameter D₁. The ends of the two arcs 26, 28 meet at respective predetermined locations denoted as Mₚ in FIG. 4A so as to create an ovoid cross-sectional shape O_{XA} having a single axis of symmetry, denoted by X_{sym}. The axis of symmetry X_{sym} extends through both the centre 26_{C} of the first arc 26 and the centre 28_{C} of the second arc 28. As can be seen, the buccal surface 24 is not flat but bulges outward slightly with a reduced curvature relative to that of the first arc 26 of the ovoid cross-sectional shape O_{XA}.

FIG. 4B shows a schematic drawing illustrating how the ovoid cross-sectional shape O_{XA} in FIG. 4A can be derived. Firstly, FIG. 4B shows a first circle C₁ having a diameter that corresponds to the first diameter D₁ of the first arc 26 which defines the first curved surface 22 of the implant 2. FIG. 4B also shows a larger second circle C₂ overlapping the first circle C₁. The diameter D₂ of the second circle C₂ is larger than that of the first circle C₁ by a predetermined numerical factor and corresponds with the second diameter D₂ of the second arc 28, and thus the curvature of the buccal surface 24. Although the curvature of the buccal surface 24 is shown as an arc of constant diameter, it may also be formed from an arc with a diameter that varies along a length of the implant 2.

In FIG. 4B, the second circle C₂ is aligned with, overlaps and intersects the first circle C₁ at two points; these two points of intersection define the aforementioned meeting points Mₚ of the first and second arcs 26, 28. FIG. 4B also shows a pair of third circles C₃ which are identical, spaced apart, and contained within the first circle C₁. These third circles C₃ are proportionally smaller than both the first and second circles C₁, C₂. In the depicted embodiment, the diameters of the third circles C₃ are smaller than that of the first circle C₁ by approximately the square root of the aforementioned predetermined numerical factor. The diameters of the third circles C₃ are thus smaller than that of the second circle C₂ by a cube root of the predetermined numerical factor. As can be seen, the second circle C₂ intersects the first circle C₁ at locations where the respective third circles C₃ tangentially intersect both the first and second circles C₁, C₂. Of course, the second circle C₂ can intersect the first circle C₁ at other locations (e.g., by insetting the third circles C₃ to a different extent within the first circle C₁). For example, referring to FIG. 4B, the third circles C₃ could be moved further rightwards or leftwards within the first circle C₁ to alter where the first and second circles C₁, C₂ intersect to determine the configuration of the buccal surface 24. Indeed, the configuration of the buccal surface 24 can vary as needed to suit the needs of the patient, preferably to ensure a relatively smooth transition between the first curved surface 22 and the buccal surface so as to avoid or minimise any sharp edges.

FIG. 4B simply illustrates one manner via which a configuration of the buccal surface 24 can be determined, though of course the curved configuration thereof can be determined via other methods. The present specification thus includes within its scope any number of differently configured zygomatic implants 2 wherein the intermediate and/or coronal portions 14, 8 have an ovoid cross-sectional shape O_{XA}, preferably one that is defined by the meeting of two different curves or arcs. With reference to FIG. 4B, the predetermined numerical factor by which the differently sized circles C₁, C₂, C₃ are proportioned relative to one another is approximately 1.618 (also referred to as the golden ratio), though of course other predetermined numerical factors may be utilised (e.g., any factor between 1 and 2). Of course, the predetermined numerical factor need not be consistent across all of the circles C₁, C₂, C₃. For example, the numerical factor relating the first and second circles C₁, C₂ need not also relate the first and third circles C₁, C₃, and so on.

While the Figures show a generally asymmetric zygomatic implant 2, the scope of the present specification also includes zygomatic implants 2 having at least one plane of symmetry. For example, certain implant embodiments may comprise intermediate and coronal portions 14, 8 comprising a generally constant ovoid cross-section. In such implants, the ovoid cross-sectional shape stays relatively constant as one moves upwardly along the length of the implant 2 toward the coronal portion 8. As will now be discussed, the ovoid cross-sectional shape O_{X} of the implant 2 depicted in the Figures is not constant, and instead varies along a length of the intermediate and coronal portions 14, 8.

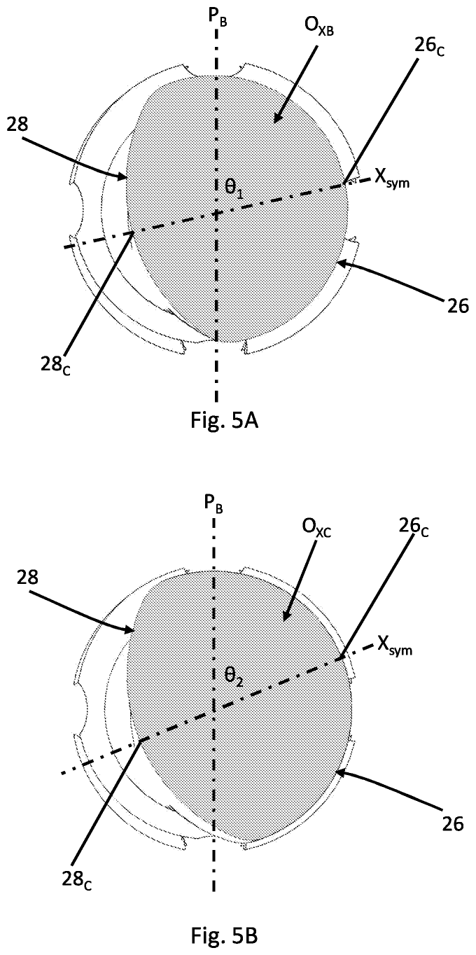

Referring to FIG. 2B, moving from a lower end of the intermediate portion 14 upwards in the direction of the coronal portion 8, it can be seen that the buccal surface 24 grows in size and becomes increasingly offset or unaligned from the central longitudinal axis X_{A}. Put another way, if a lateral line were to be drawn from one side of the curved buccal surface 24 to the other side thereof, then such a line would grow longer and more offset from the central longitudinal axis X_{A} in the direction of the coronal portion 8. This can be seen by comparing the laterally extending lines denoted L_{A} and L_{C} in FIG. 2B. This shifting or twisting of the buccal surface 24 along a length of the implant 2 is also evident by comparing FIGS. 4A, 5A and 5B.

FIGS. 4A, 5A and 5B each show a vertically oriented plane that extends through and bisects the apical portion, denoted P_{B}. As can be seen in FIG. 4A, the axis of symmetry X_{sym} extending through the ovoid cross-sectional shape O_{XA} is generally perpendicular to the bisecting plane P_{B}.

FIGS. 5A and 5B show the ovoid cross-sectional shapes O_{XB}, O_{XC} of the coronal portion 8 of the implant 2 along the planes denoted by B-B and C-C in FIG. 2A, respectively. As can be seen by comparing FIG. 5A with FIG. 4A, the centre 28_{C} of the second arc 28 in FIG. 5A, and thus the axis of symmetry X_{sym}, has rotated or moved in a counter-clockwise direction relative to the bisecting plane P_{B}, so as to form an acute angle θ₁ therewith. Moving further in the direction of the coronal portion 8 to arrive at the ovoid cross-sectional shape O_{XC} taken at C-C and shown in FIG. 5B, the centre 28_{C} of the second arc 28 and axis of symmetry X_{sym} passing therethrough has rotated or moved even further, forming an even more acute angle θ₂ with the bisecting plane P_{B}. In other words, moving in the direction of the coronal portion 8, the second arc 28 grows larger in size and the position thereof gradually twists in a counter-clockwise direction. In this way, while a perimeter of the ovoid cross-sectional shape Ox is primarily defined by a length of the first arc 26, the length of the perimeter is increasingly defined by the length of the second arc 28 as one travels up the implant 2 toward the coronal portion 8. In other words, the size of the buccal surface 24 increases in the direction of the coronal portion 8 relative to the first curved surface 22 of the implant 2.

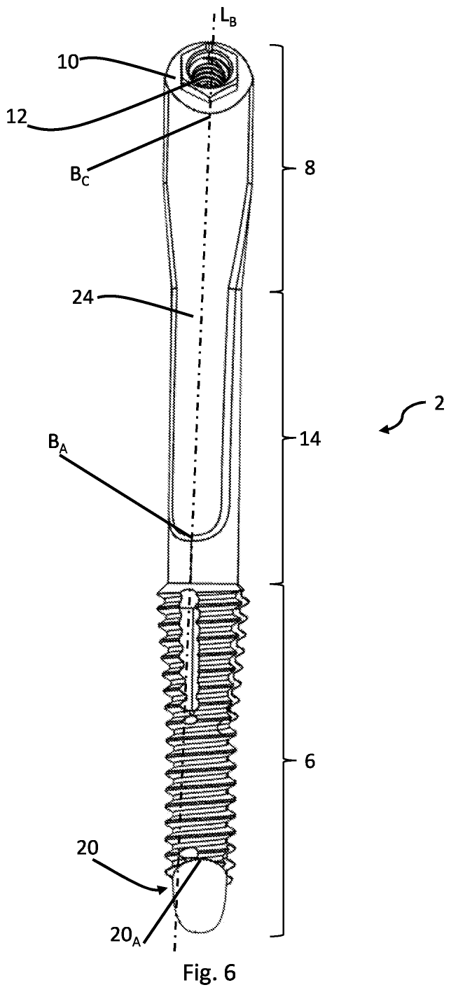

In the depicted embodiment, it is envisioned that the axis of symmetry X_{sym} Of the ovoid cross-sectional shape O_{X} toward or at a top of the coronal portion 8 (e.g., FIG. 5B) has twisted or rotated counterclockwise relative to its original orientation (e.g., FIG. 4A) by approximately 22.5 degrees. Of course, a rotation up to 90 degrees is within the scope of the present specification. This changing configuration of the curved buccal surface 24, and the associated movement of the centre 28_{C} of the second arc 28 along the intermediate and coronal portions 14, 8, is illustrated by the dashed line denoted L_{B} in FIG. 6. The dashed line L_{B} is drawn such that it passes through both a centre B_{A} of the curved buccal surface 24 at a lower end of the intermediate portion (which corresponds with the centre of the second arc 28 at that location), as well as a centre B_{C} of the curved buccal surface 24 at an upper end of the coronal portion 8; as can be seen, the dashed line L_{B} is slightly angled relative to the vertical.

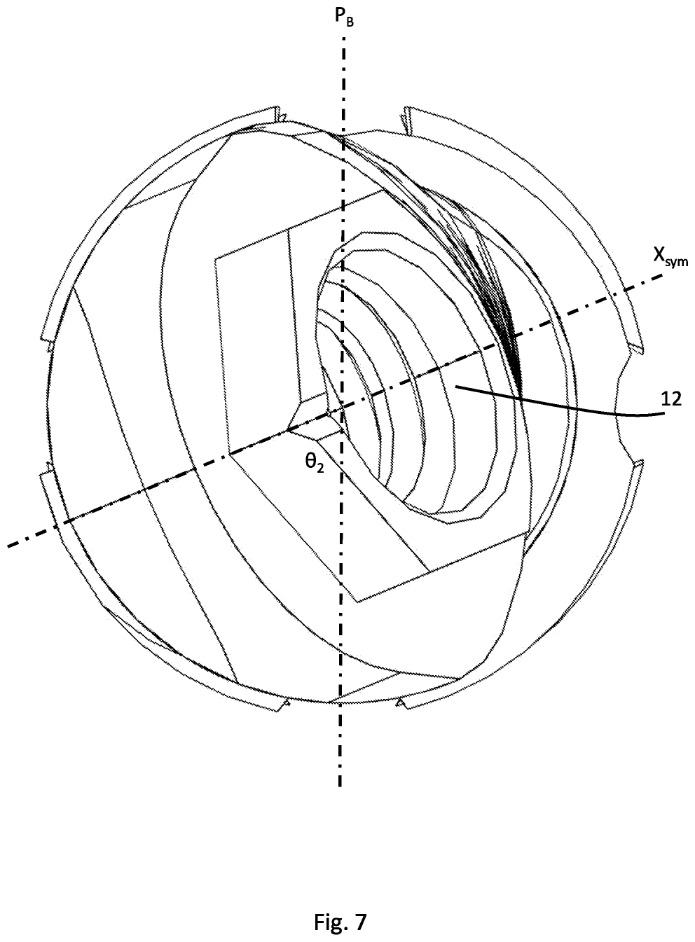

Still referring to FIG. 6, the planar platform 10 and associated interior threaded bore 12 of the coronal portion 8 are oriented so as to be aligned with a centre of the second arc 28 of the ovoid cross-sectional shape O_{X} at or toward a top of the coronal portion 8 (i.e., the location indicated by B_{C}). In other words, the threaded bore 12 is generally aligned with the axis of symmetry X_{sym} of the buccal surface 24 toward an upper end of the coronal portion 8. This alignment of the threaded bore 12 with the axis of symmetry X_{sym} can also be seen in FIG. 7. The resulting platform 10 and bore 12, which are twisted slightly in the counterclockwise direction, help to correct or compensate for the angulation of the zygomatic implant 2 so that in situ, the bore 12 is closer to or at the desired orientation and position for engagement with an attachment, such as an abutment. The extent to which the buccal surface 24 and thus interior bore 12 are twisted about the central longitudinal axis X_{A} may of course vary and be customised to suit the specific patient, and may help reduce or eliminate the need for an angulated abutment, thereby allowing for less bulky abutments and the like to be engaged with the present implant 2.

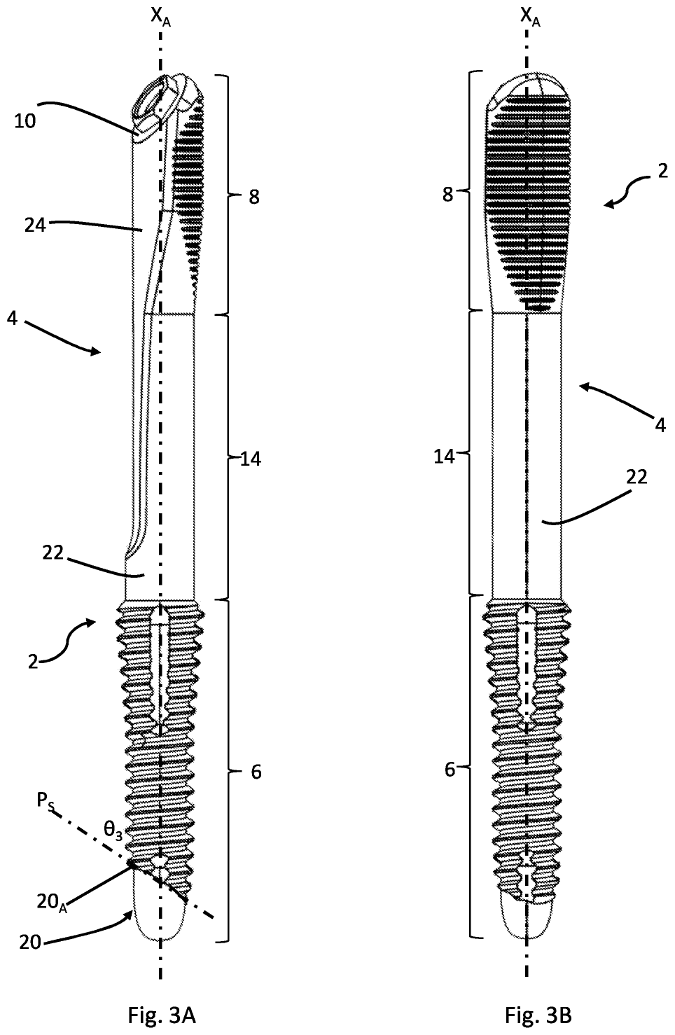

Referring to FIGS. 1 to 3B, 6 and 9, the depicted implant 2 comprises a smooth and unthreaded tip portion 20 that is not symmetrically disposed about the central longitudinal axis X_{A}. In the depicted embodiment, the smooth polished tip portion 20 approximates the form of a spheroid, and in particular, a prolate spheroid an upper end of which has been cut by an imaginary angled plane. This is illustrated in FIG. 3A, which shows a plane P_{S} angled relative to the central longitudinal axis X_{A} which passes through and defines an upper end of the smooth tip portion 20. In the depicted embodiment, the plane Pₛ is angled at approximately 35 degrees θ₃ from the longitudinal axis X_{A}, though of course the angle may vary. In this way, the upper end of the smooth tip portion 20 comprises a lowermost first end coincident with a first side of the apical portion 6, and an uppermost second end coincident with an opposite side of the apical portion 6, the uppermost second end defining a top or apex 20_{A} of the polished tip portion 20.

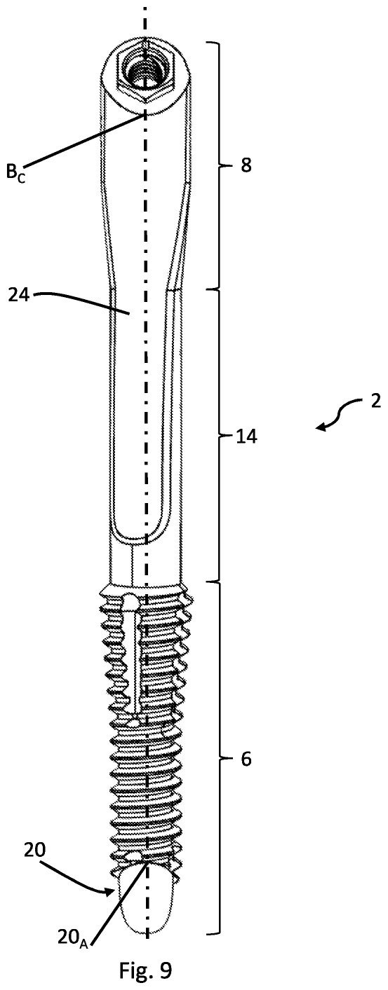

Referring to FIG. 9, it can be seen that the apex or top 20_{A} of the polished tip portion 20 is oriented so that it is aligned with the centre of the second arc B_{C} at an upper end of the coronal portion 8. In other words, the apex 20_{A} of the polished tip portion 20 and the centre of the second arc B_{C} at the upper end of the coronal portion 8 substantially lie on the same vertical axis. It should be noted that in the depicted embodiment, this vertical axis is not coincident with the central longitudinal axis X_{A} of the apical portion 6, and is instead parallel thereto. However, the scope of the present specification does of course encompass embodiments wherein the aforementioned axes may be coincident.

The presently disclosed and depicted angled smooth tip portion 20 is configured such that one side thereof, corresponding to the side with the apex 20_{A}, provides a larger polished surface area than the opposite side. When implanted, this larger polished surface area is configured to engage the patient's soft tissue and reduces the likelihood that any external threading 16 of the apical portion 6 will contact, engage or otherwise irritate the patient's soft tissue. Advantageously, by aligning both the directionality of the apex 20_{A} (and thus the larger surface area of the polished tip 20) with the centre of the buccal surface 24 at an upper end thereof, the present implant 2 allows for improved orientation and engagement of the smooth buccal surface 24r and polished tip 20 with the patient's soft tissue, thereby reducing irritation and/or risk of infection.

While the depicted embodiment shows an implant 2 whose buccal surface 24 twists, turns or rotates in a counterclockwise direction, the buccal surface 24 can similarly twist, turn or rotate in the opposite clockwise direction. In this way, present implants can have a handedness to them which can make them more comfortable and suitable for the left or right-handed side of a patient's face. For example, an implant with a curved buccal surface that twists counterclockwise may be more suitable for the right side of the patient's face (looking at the patient's face) and more comfortably engage the soft tissue thereof, whereas a clockwise twisting buccal surface may be more suitable for the opposite side.

In alternative embodiments, and as discussed previously, the scope of the present specification also covers implants 2 wherein the ovoid cross-section Ox remains relatively constant along a length of the implant 2. In certain examples of such embodiments, particularly if the implant 2 is to incorporate rotation of the coronal platform 10 and associated bore 12, it is envisaged that the direction in which the axis of symmetry X_{sym} points remains relatively constant along the length of the implant 2, until closer to a top of the buccal surface 24 at or toward an upper end of the coronal portion 8, at which location the axis of symmetry X_{sym} may thus twist about the longitudinal axis X_{A}, as previously described, to allow for rotation of the coronal platform 10 and bore 12.

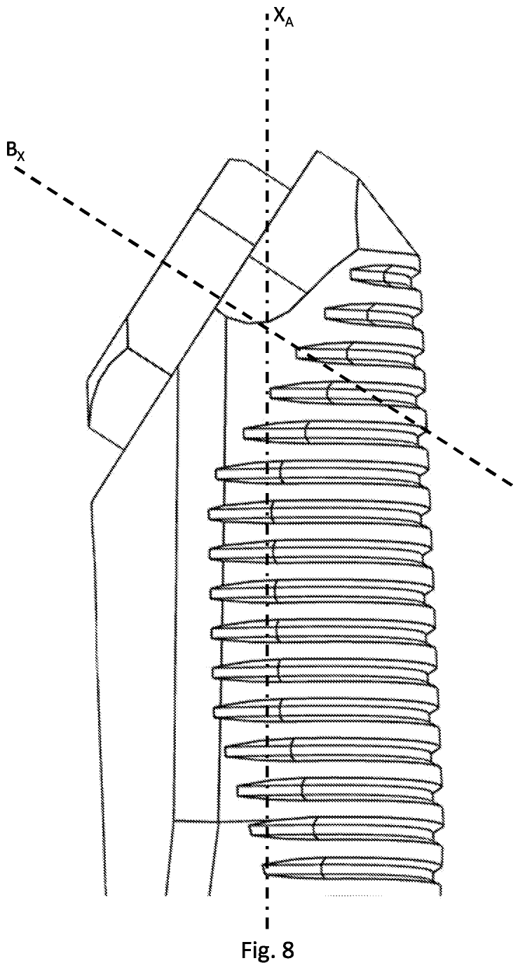

Many modifications of the above embodiments will be apparent to those skilled in the art without departing from the scope of the present invention. For example, the configuration of the curved buccal surface may vary and be customised to meet the needs of a specific patient. For example, the curvature of the buccal surface may be larger, smaller, offset from the bisecting plane to different extents, vary in how gradually it twists (if at all) etc. FIG. 8 shows the planar platform 10 of the coronal portion 8 being angled approximately 45 to 55 degrees from the central longitudinal axis X_{A} (or 35 to 45 degrees from a plane perpendicular thereto) though of course the angle of the platform 10 may vary as needed. FIG. 8 also shows how the central axis B_{X} of the threaded bore is generally perpendicular to the plane of the planar platform 10.

While the Figures depict a coronal portion 8 having circumferentially extending grooves extending along the first curved surface 22 (i.e., on a side opposite to that of the buccal surface), such grooves are of course optional and this surface can indeed simply be smooth.

Embodiments of the present implant may thus have softened buccal contours to more harmoniously follow the bony envelope of the patient. Moreover, the rotationally offset platform and interior bore may help improve positioning of the implant and reduce reliance on angulated abutments.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A zygomatic dental implant having an elongate body comprising:
an elongate apical portion for anchoring the implant in zygoma bone of a patient, the apical portion having a central longitudinal axis;
a coronal portion having an internally threaded bore via which an abutment can be engaged with the implant; and
an intermediate portion extending between the apical portion and the coronal portion,
wherein a cross-sectional shape of the intermediate portion and/or the coronal portion, taken along a plane perpendicular to the central longitudinal axis, is ovoid.

2. The implant of claim 1, wherein the ovoid cross-sectional shape is formed by a meeting of first and second curves having different lengths, the first curve comprising a first arc having a first diameter and the second curve comprising a second arc having a second diameter that is different from the first diameter.

3. (canceled)

4. The implant of claim 2, wherein a majority of a perimeter of the ovoid cross-sectional shape is defined by the first arc.

5. The implant of claim 4, wherein, moving in a coronal direction, the perimeter of the ovoid cross-sectional shape is increasingly defined by the second arc.

6. The implant of claim 5, wherein the ovoid cross-sectional shape comprises an axis of symmetry passing through respective centres of the first and second arcs.

7. The implant of claim 6, wherein the central longitudinal axis lies on a plane that bisects the apical portion, and wherein the axis of symmetry at a lower end of the intermediate portion is generally perpendicular to the plane.

8. The implant of claim 7, wherein, moving in the coronal direction, the axis of symmetry grows increasingly acute relative to the plane that bisects the apical portion.

9. The implant of claim 8, wherein, moving in the coronal direction, the centre of the second arc rotates up to 90 degrees about the central longitudinal axis.

10. The implant of claim wherein the coronal portion comprises a generally planar platform facing a direction that is aligned with the centre of the second arc at an upper end of the coronal portion.

11. The implant of claim 10, wherein the platform is angled from the plane that is perpendicular to the central longitudinal axis.

12. The implant of claim 11, wherein the implant is angled by approximately 35 degrees to 45 degrees from the plane that is perpendicular to the central longitudinal axis.

13. The implant of claims 10, wherein the internally threaded bore has a central bore axis that is generally perpendicular to the planar platform.

14. The implant of claim 2, wherein:
the first arc forms part of a first circle having the first diameter; and
the second arc forms part of a second circle having the second diameter, the second diameter being greater than the first diameter by a predetermined numerical factor.

15. The implant of claim 14, wherein the first and second arcs meet at an intersection where a pair of third identical circles, each spaced from one another and contained within the first circle and having a third diameter that is the square root of the predetermined numerical factor, tangentially intersect both the first circle and the second circle.

16. The implant of claim 14, wherein the predetermined numerical factor is between approximately 1 and 2.

17. (canceled)

18. The implant of claim 2, wherein the apical portion comprises external threading and a smooth unthreaded tip portion.

19. The implant of claim 18, wherein an upper end of the smooth unthreaded tip portion slopes upwardly from a first side of the apical portion about the circumference thereof to an opposite second side of the apical portion so as to define an apex of the smooth unthreaded tip portion.

20. The implant of claim 19, wherein the slope is angled between approximately 10 to 60 degrees relative to the central longitudinal axis.

21. The implant of claim 19, wherein the apex of the smooth unthreaded tip portion is aligned with the centre of the second arc at an upper end of the coronal portion.
